(19) United States
(12) Patent Application Publication
(10) Pub. No.: US 2016/0069489 A1
(43) Pub. Date: Mar. 10, 2016

(54) Hose Connection Device

(71) Applicant: puteus GmbH, Toenisvorst (DE)

(72) Inventor: Peter de Gruyter, Toenisvorst (DE)

(21) Appl. No.: 14/846,936

(22) Filed: Sep. 7, 2015

(30) Foreign Application Priority Data
Sep. 8, 2014 (DE) 10 2014 112 906.7

(51) Int. Cl. F16L 25/00; F16L 37/28; F16L 33/18; F16L 37/02; F16L 29/00; F16L 31/00

(52) U.S. Cl. CPC F16L 25/0018; F16L 29/007; F16L 31/00; F16L 33/18; F16L 37/02; F16L 37/28

(57) ABSTRACT

The invention relates to a hose connecting device (1) for connecting at least one hose, comprising at least, one hollow connecting section (2, 2′) which has a fluid flow opening (20) in its interior and is sized and shaped so that a hose is directly attachable on the connecting section (2, 2′) from the outside, wherein at least one sealing element (30, 31, 32, 30′, 31′, 32′) is arranged on the connecting section (2).

### BACKGROUND OF THE INVENTION

This application claims priority to DE 10 2014 112 906.7 filed on Sep. 8, 2014. The present invention relates to a hose connection device for connecting at least one hose, comprising at least one hollow connecting section which has in its interior a fluid flow opening and is sized and shaped so that a hose is directly plugged on this opening from the outside.

Various embodiments of hose connection devices of the aforementioned type are already known in the art. In these hose connection devices, a hose is directly placed onto the connecting section from the outside without using a connection adapter or the like. In order to secure the hose on the connecting section against undesired detachment and to prevent fluid leakage from this arrangement, the connecting section may have a rib structure on its outer side. The hose is additionally secured on the connecting section from the outside by means of a clamping device.

The hose connection devices known from the prior art have the disadvantage that undesirable fluid leakage cannot always be reliably prevented. Furthermore, the establishment of a vacuum cannot always be guaranteed. The clamping device that secures the hose to the connecting section can hence slightly detach in certain situations, thereby reducing the clamping force. As a result, although the hose is still held on the connecting section, at least a small amount of the fluid can flow between an inner wall of the hose and an outer wall of the connecting section.

### BRIEF SUMMARY OF THE INVENTION

It is therefore an object of the present invention to provide a hose connecting device with an improved seal.

The solution of this object is thus attained with a hose connecting device of the aforementioned type with the features of the characterizing portion of claim 1. The dependent claims relate to advantageous embodiments of the invention.

A hose connecting device according to the invention is characterized in that at least one sealing element is attached at the connecting section. By providing at least one sealing element, an improved seal is produced. The at least one sealing element can furthermore improve the build-up of a vacuum, compensate for manufacturing tolerances and manufacturing imprecisions of both the connecting section and the hose as well as prevent contamination of the fluid flowing therethrough (e.g., by an adhesive that may be used for sealing).

In a preferred embodiment, to increase the sealing effect, it is proposed to attach to the connecting section, several sealing elements spaced-apart in the longitudinal direction.

According to a particularly preferred embodiment, to securely hold the sealing elements on the connecting section, the connecting section may include a number of annular receiving grooves, extending in the circumferential direction and corresponding to the number of sealing elements, wherein a respective one of the sealing elements is arranged in each of the receiving grooves. Arranging the sealing elements in their associated receiving grooves can advantageously prevent the sealing elements from slipping when attaching or removing the hose. In principle, several sealing elements may be arranged in each of the receiving grooves.

Preferably, the connecting section may, when viewed in the longitudinal direction, include a number of circumferentially extending, substantially frusto-conically shaped outer wall sections, wherein preferably at least one of the receiving grooves is formed in each of the outer wall sections. Here, a recess from a larger outside diameter to a smaller outside diameter is formed between adjacent frusta-conically shaped outer wall sections. Attachment of the hose can thus be simplified. In other words, the outer wall sections have a rib-like structure. In this way, the hose is frictionally pre-fixing at the connecting section. Basically, the at least one connecting section may also lack a rib-like structure on its exterior, making it smooth. At least one sealing element may also be mounted on the connecting section formed in this way.

In a preferred development of the invention, the hose connecting device may have a first connecting section that is sized and shaped so that a first hose is directly attachable thereon from the outside, and at least one second connecting section that is sized and shaped so that a second hose is directly attachable thereto from the outside, wherein at least one sealing element is attached at each of the connecting sections. At least two hoses can then be connected to each other. A respective hose is placed on each of the two connecting sections during arrangement and secured by using at least one clamping device. The arrangement is additionally sealed in this area because at least one sealing element is attached at each of the connecting sections.

In order to improve sealing of the arrangement after attachment of the hoses, it is proposed in a preferred embodiment to attach to the connecting sections several sealing elements that are spaced-apart in the longitudinal direction.

For a secure fit of the sealing elements, it has proven advantageous that each connecting section includes a number of circumferentially extending annular receiving grooves corresponding to the number of sealing elements, wherein a respective one of the sealing elements is arranged in each of the receiving grooves. This can reliably prevent undesired slipping of the sealing elements when the hose is attached or removed. In principle, several sealing elements may be arranged in each of the receiving grooves.

Preferably, at least one of the connecting sections may have, as viewed in the longitudinal direction, a number have circumferentially extending, substantially frusto-conically shaped outer wall sections, wherein preferably at least one of the receiving grooves is formed in each of the outer wall sections. All connecting sections of the hose connecting device can advantageously be formed in this manner. A recess from a larger outside diameter to a smaller outer diameter is formed between adjacent frusto-conically shaped outer wall sections, thereby simplifying the attachment of the hose(s) and enabling frictional pre-affixing in the areas with a larger outer diameter, where the connecting sections are formed as ribs. Fundamentally, the connecting sections may also lack a ridge-like structure at their outer sides and may therefore be smooth. At least one sealing element can also be installed on the connecting sections formed in this way.

The sealing elements may advantageously be designed as sealing rings and preferably made of a rubber-elastic material. The sealing rings may also be made of a material without rubber-elastic properties (for example, PTFE).

In order to selectively open and close the flow connection between the connecting sections, it is proposed in a preferred embodiment to arrange a shut-off device between the connecting sections. The connecting sections can advantageously be connected with the shut-off device by sealed screw connections. Preferably, the shut-off device may be a ball valve, which is particularly distinguished by a robust mechanical construction and also has a low flow resistance and can be quickly opened and closed.

In another advantageous embodiment, the hose connecting device may be formed integrally with a valve, in particular a drain valve or a shutoff valve, or may have at least one connecting means constructed to connect the hose connecting device with a valve, in particular with a drain valve.

### BRIEF DESCRIPTION OF THE DRAWINGS

Additional features and advantages of the present invention will become apparent from the following description of preferred embodiments with reference to the accompanying drawings, wherein:

FIG. 1 shows a longitudinal section through a part of a hose connecting device constructed according to a first exemplary embodiment of the present invention,

FIG. 2 shows a side view of a hose connecting device constructed according to a second exemplary embodiment of the present invention,

FIG. 3 shows a perspective view of the hose connecting device according to FIG. 2.

### DETAILED DESCRIPTION OF THE INVENTION

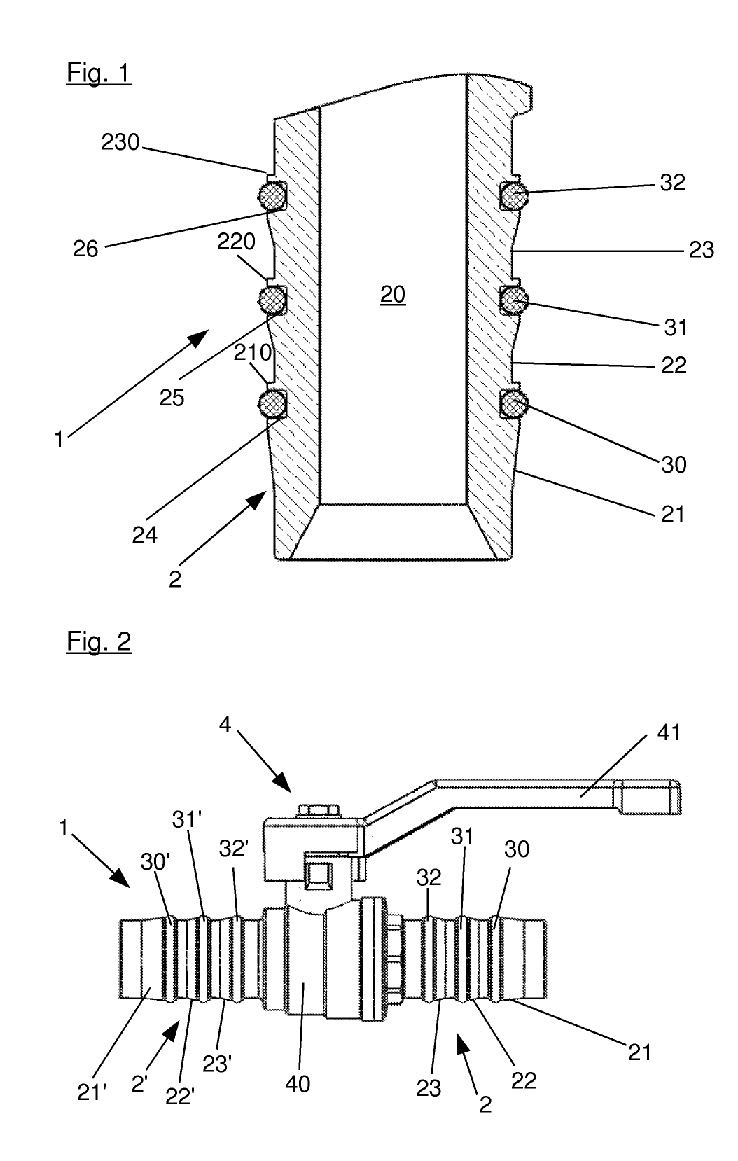

Referring now to FIG. 1, a hose connecting device 1 constructed to connect at least one hose includes at least one hollow connecting section 2 with a fluid flow opening 20 disposed in its interior, through which a fluid, in particular water can flow. This connecting section 2 is dimensioned and shaped so that a hose can be directly placed over its outside without using a connection adapter or like. The connection section 2 has in a known manner, as viewed in the longitudinal direction, three circumferentially extending and essentially frusto-conically shaped outer wall sections 21, 22, 23. A respective recess 210, 220, 230 from a larger outer diameter to a smaller outer diameter is formed at a rear end of each outer wall section 21, 22, 23, as viewed in the longitudinal direction. In other words, the outer wall sections 21, 22, 23 thus have a rib-like structure. More particularly, the frusta-conical shape of the outer wall sections 21, 22, 23 facilitates attachment of a hose on the connecting section 2. The recesses 210, 220, 230 have the effect that the hose attached to the connecting section 2 can be held and pre-affixed by friction on these adjacent regions of the outer wall sections 21, 22, 23 having the larger outer diameter. In order to secure the hose to the connecting section 2 and to seal this arrangement, the hose is additionally secured from the outside by means of a clamping device. The clamping device can, for example, be a hose clamp or have clamping shells or similar clamping means.

In order to improve sealing of the arrangement after attaching and affixing the hose by means of the clamping device, the connecting section 2 has three longitudinally spaced-apart, annular sealing elements 30, 31, 32, which are preferably made of a rubber-elastic material. The sealing elements 30, 31, 32 may alternatively also be made of a material devoid of rubber-elastic properties (for example, PTFE). The connecting section 2 also has three annular, circumferentially extending receiving grooves 24, 25, 26, which can be prepared, for example, by removing material by cutting, in particular by lathe-cutting into the outer wall sections 21, 22, 23. A respective one of the sealing elements 30, 31, 32 is arranged in each of the receiving grooves 24, 25, 26. Advantageously, the sealing elements 30, 31, 32 create an additional seal of the arrangement following attachment of the hose, thereby offering improved protection against leaks. The arrangement of the sealing elements 30, 31, 32 in the receiving grooves 24, 25, 26 can advantageously prevent the sealing elements 30, 31, 32 from slipping when the hose is attached to the connection section 2. In principle, several sealing elements 30, 31, 32 may also be arranged in the respective receiving grooves 24, 25, 26.

The hose connecting device 1 may for example be integrally formed with a valve, in particular a discharge valve (not explicitly illustrated here). The hose connecting device 1 may also include at least one connecting means which is constructed so that the hose connecting device 1 can be releasably connected to such a valve. The connection means may for example be a screw connection means.

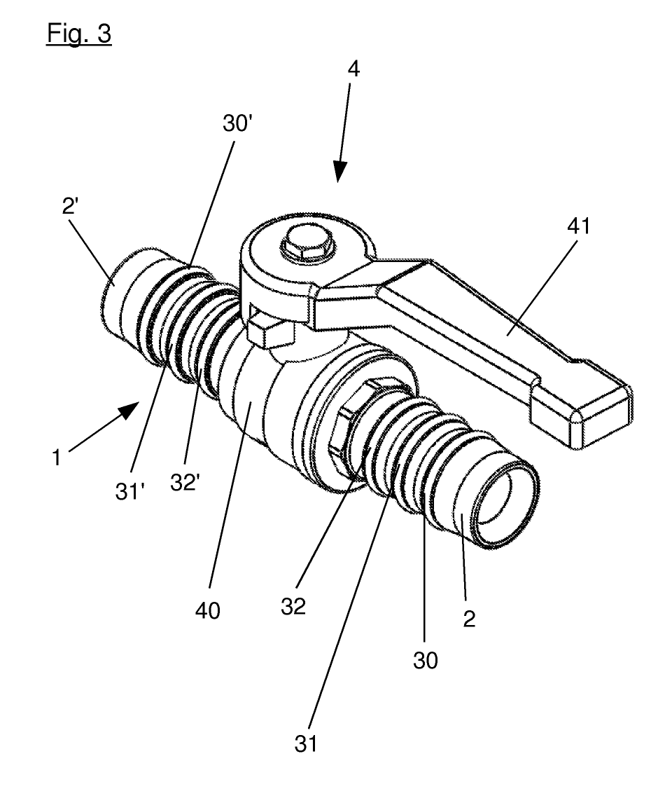

A hose connecting device 1 constructed according to a second exemplary embodiment of the present invention will now be explained in more detail below with reference to FIGS. 2 and 3. This hose connecting device 1 is configured such that a respective hose can be connected at opposite ends. In other words, at least two hoses can be joined by way of this hose connecting device 1.

The hose connecting device 1 has a first connecting section 2 and a second connecting section 2′, both of which are again hollow and have each in their interior a respective fluid flow opening, through which a fluid can flow. The two connecting sections 2, 2′ are constructed so that a respective hose can be placed directly over these connecting sections 2, 2′ from the outside without using an additional connection adapter or the like. Each of the two connecting sections 2, 2′ has in this embodiment three circumferentially extending, substantially frusto-conically shaped outer wall sections 21, 22, 23, 21′, 22′, 23′. A respective recess from a larger outer diameter to a smaller outer diameter is formed—analogous to the hose connecting device 1 according to the first embodiment—at a rear end of each outer wall section 21, 22, 23, 21′, 22′, 23′, as viewed in the longitudinal direction. As already explained above, the truncated conical configuration of the outer wall sections 21, 22, 23, 21′, 22′, 23′ facilitates attachment of the hoses on the connecting sections 2, 2′. The recesses produce a rib-like structure of the connecting sections 2, 2′, with the effect that the hoses placed over the respective connecting sections 2, 2′ are held and thus pre-affixed in these adjacent regions of the outer wall sections 21, 22, 23, 21′, 22′, 23′ having a larger outer diameter by a frictional connection. In order to secure and seal the hoses on the respective connecting section 2, 2′, the hoses are in turn additionally secured from the outside by means of a respective clamping device. The clamping devices may, for example, be hose clamps or have clamping shells or similar clamping means.

In order to improve sealing of the arrangement after the hoses are attached and secured, each of the two connecting sections 2, 2′ includes three longitudinally spaced-apart, annular sealing elements 30, 31, 32, 30′, 31′, 32′, which are made in particular of a rubber-elastic material. The sealing elements 30, 31, 32, 30′, 31′, 32′ may alternatively also be made of a material without rubber-elastic properties (for example, PTFE). Each of the two connecting sections 2, 2′ has, as viewed in the longitudinal direction, three annular, circumferentially extending receiving grooves prepared, for example, by removal material by cutting, in particular by lathe-cutting into the outer wall sections 21, 22, 23, 21′, 22′, 23′. A respective one of the sealing elements 30, 31, 32, 30′, 31′, 32′ is arranged in each of the receiving grooves. The sealing elements 30, 31, 32, 30′, 31′, 32′ advantageously provide an additional seal of the arrangement after attachment of the hoses, thus improving protection against leakage. In principle, several sealing elements 30, 31, 32, 30′, 31′, 32′ may in each case be arranged in the receiving grooves.

In this exemplary embodiment, a shut-off element 4 is disposed between the two connecting sections 2, 2′, which is constructed so that a flow connection between the two connecting sections 2, 2′ can be selectively opened or closed by a user. The two connecting sections 2, 2′ are each connected by a respective sealed screwed connection with a main body 40 of the shutoff device 4. The shutoff device 4, which is in the present example designed as a so-called ball valve, has a rotatable operating handle 41, through the actuation of which the flow connection between the two connecting sections 2, 2′ can be selectively opened or closed.

According to another exemplary embodiment (not explicitly shown here), the hose connecting device 1 according to FIGS. 2 and 3 may also be constructed without the shutoff device 4. The hose connecting device 1 is then functionally a pure hose connecting device without the possibility to interrupt the flow connection between the connected hoses with the shutoff device 4.

The hose connecting device 1 can—with or without shutoff device 4—also be designed to have more than two connecting sections 2, 2′ of the type discussed above, with a hose attachable on each of the two connecting sections.

In alternative variants of the embodiments illustrated herein, the connecting sections 2, 2′ may also lack rib-like structures on their outer sides and are thus smooth. At least one sealing element 30, 31, 32, 30′, 31′, 32′ is hereby mounted on each of the connecting sections 2, 2′ formed in this way.

The sealing elements 30, 31, 32, 30′, 31′, 32′ attached at the connecting sections 2, 2′ can in all the aforedescribed embodiments not only improve sealing, but also improve build-up of a vacuum, compensate manufacturing tolerances and imprecisions of both the connecting sections 2, 2′ and the hoses attached thereto, as well as prevent contamination of the fluid flowing therethrough (for example by an adhesive that may be used for sealing).

What is claimed is:

1. A hose connecting device (1) for connecting at least one hose, comprising at least one hollow connecting section (2, 2′) which has in its interior a fluid flow opening (20) and which is sized and shaped so as to be directly placeable on the at least one hollow connecting section (2, 2′) from the outside, wherein at least one sealing element (30, 31, 32, 30′, 31′, 32′) is attached to the connecting section (2).

2. The hose connecting device (1) according to claim 1, wherein a plurality of sealing elements (30, 31, 32, 30′, 31′, 32′) that are spaced apart in the longitudinal direction are attached on the connecting section (2, 2′).

3. The hose connecting device (1) according to claim 1, wherein the connecting section (2, 2′) comprises a number of annular, circumferentially extending grooves (24, 25, 26) that corresponds to the number of sealing elements (30, 31, 32, 30′, 31′, 32′), wherein a respective one of the sealing elements (30, 31, 32, 30′, 31′, 32′) is arranged in each of the receiving grooves (24, 25, 26).

4. The hose connecting device (1) according to claim 3, wherein the connecting section (2, 2′) has, as viewed in the longitudinal direction, a plurality of substantially frusto-conical shaped outer wall sections (21, 22, 23, 21′, 22′, 23′) extending in the circumferential direction.

5. The hose connecting device (1) according to claim 1, wherein the hose connecting device (1) comprises a first connecting section (2), which is sized and shaped so that a first hose is directly attachable thereon from the outside, and at least one second connecting section (2′), which is sized and shaped so that a first hose is directly attachable thereon from the outside, wherein at least one sealing element (30, 31, 32, 30′, 31′, 32′) is arranged on each of the connecting sections (2, 2′).

6. The hose connecting device (1) according to claim 5, wherein a plurality of sealing elements (30, 31, 32, 30′, 31′, 32′) that are spaced apart in the longitudinal direction are arranged on the connecting sections (2, 2′).

7. The hose connecting device (1) according to claim 5, wherein each connecting section (2, 2′) comprises a number of annular, circumferentially extending receiving grooves (24, 25, 26) corresponding to the number of sealing elements (30, 31, 32, 30′, 31′, 32′), wherein a respective one of the sealing elements (30, 31, 32, 30′, 31′, 32′) is arranged in each of the receiving grooves (24, 25, 26).

8. The hose connecting device (1) according to claim 7, wherein at least one of the connecting sections (2, 2′), as viewed in the longitudinal direction, comprises a number of substantially frusta-conical shaped outer wall sections (21, 22, 23, 21′, 22′, 23′) extending in the circumferential direction, wherein preferably at least one of the receiving grooves (24, 25, 26) is formed in each of outer wall sections (21, 22, 23, 21′, 22′, 23′).

9. The hose connecting device (1) according to claim 1, wherein the sealing elements (30, 31, 32, 30′, 31′, 32′) are constructed as sealing rings, which are preferably made of a rubber-elastic material.

10. The hose connecting device (1) according to claim 1, wherein a shutoff device (4) is arranged between the connecting sections (2, 2′).

11. The hose connecting device (1) according to claim 1, wherein the hose connecting device (1) is formed integrally with a valve, in particular a drain valve, or comprises at least one connecting means, by means of which the hose connecting device can be connected with a valve.

12. The hose connecting device (1) according to claim 4, wherein, wherein at least one of the receiving grooves (24, 25, 26) is formed in each of outer wall sections (21, 22, 23, 21′, 22′, 23′).

13. The hose connecting device (1) according to claim 10, wherein a shutoff device (4) is a ball valve and is arranged between the connecting sections (2, 2′).

14. The hose connecting device (1) according to claim 11, wherein the valve is a drain valve, or comprises at least one connecting means, by which the hose connecting device is connectable with a drain valve or a shutoff valve.
